(19) United States
(12) Patent Application Publication
(10) Pub. No.: US 2026/0278434 A1
(43) Pub. Date: Sep. 17, 2026

(54) ANALOG DATA REPRESENTATION USING QUANTUM COMPUTING

(71) Applicant: Oracle International Corporation, Redwood Shores, CA (US)

(72) Inventor: Heather Marie Huggins, Thousand Oaks, CA (US)

(73) Assignee: Oracle International Corporation, Redwood Shores, CA (US)

(21) Appl. No.: 19/039,500

(22) Filed: Jan. 28, 2025

(51) Int. Cl. G06N 10/20; G06N 10/40

(52) U.S. Cl. CPC G06N 10/20; G06N 10/40

(57) ABSTRACT

A method can include receiving an input analog signal that is a signal that varies continuously in amplitude and frequency over time and can take any value within a predetermined range. The method can include generating a conditioned analog signal from the input analog signal. The method can include encoding a qubit to represent the conditioned analog signal by storing a continuous analog signal. Encoding the qubit can include encoding an amplitude associated with the conditioned analog signal into the qubit. Encoding the qubit can include encoding a phase associated with the conditioned analog signal into the qubit.

### FIELD

The present disclosure relates to quantum computing frameworks. More specifically, but not necessarily exclusively, a novel quantum computing system is described that can be used to encode a qubit by adjusting a state of the qubit to correspond with a continuous analog signal. The analog signal is represented in a quantum computing environment by changing the state of the qubit continuously over time such that the qubit encodes information corresponding with the reference analog signal.

### BACKGROUND

Traditional computing methods, including classical and quantum computing, face limitations in both accurately and efficiently representing and processing continuous data. Classical computing relies on discrete representations (integers, floating points) that miss subtle variations in the data, leading to compounding inaccuracies when acting on large data sets. Traditional quantum computing focuses on probabilities derived from quantum states, which can result in a loss of nuanced data due to the measurement process, which collapses qubit states into binary outcomes.

Traditional computing devices can capture and store data digitally. That is, the traditional computing devices use binary computing to measure and store data. The traditional computing devices can receive data, such as via capturing an image via a digital camera, and can convert the received data into a binary representation of the data such as a set of ones and zeros that represent the captured image. Other types of received data, such as mathematical calculations, electrical signals, etc., are possible to be received the traditional computing devices. Binary representations of data are problematic in certain situations. For example, binary representations of data involve sampled or discretized data corresponding to certain points of time. The sampling or discretization of the data inherently loses some data from a continuous data stream. Additionally, the traditional computing devices have a limit on the number of places past the decimal point that can be stored, so the traditional computing devices perform rounding on continuous data to be able to store the data. As the use of computing systems continues to exponentially increase, reducing or removing the rounding errors and/or the errors relating to discretizing or sampling continuous data may be difficult.

### BRIEF SUMMARY

The present disclosure relates to quantum computing. For example, a quantum computing framework can be leveraged to represent continuous analog data using one or more qubits. In some embodiments, the quantum computing framework can mimic neuronal activity by representing data as graded potentials. The quantum computing framework can leverage the continuous amplitudes of qubits for more detailed and precise data representation. In some examples, and by using Quantum Fourier Transforms (QFT) for summation, and quantum measurements for adaptive threshold detection, techniques involving the quantum computing framework can preserve the nuances of continuous data such as without rounding errors, sampling errors, etc. The quantum computing framework can thus enable richer data representation, faster and more efficient computation, and more robust decision-making.

Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure.

According to some embodiments disclosed herein, a method can include receiving an input analog signal, wherein the input analog signal is a signal that varies continuously in amplitude and frequency over time and can take any value within a predetermined range. The method can include generating a conditioned analog signal from the input analog signal. The method can include encoding a qubit to represent the conditioned analog signal by storing a continuous analog signal. Encoding the qubit can include encoding an amplitude associated with the conditioned analog signal into the qubit. Encoding the qubit can additionally include encoding a phase associated with the conditioned analog signal into the qubit.

In some embodiments, encoding the amplitude associated with the conditioned analog signal into the qubit can include (i) adjusting, using a variable gain amplifier, the amplitude associated with the conditioned analog signal to generate an adjusted signal amplitude, and (ii) controlling, by an amplitude modulator, a first quantum gate to cause the first quantum gate to adjust a state of the qubit based on the adjusted signal amplitude.

In some embodiments, encoding the phase associated with the conditioned analog signal into the qubit can include (i) adjusting, using a phase-locked loop, the phase associated with the conditioned analog signal to generate a stabilized signal phase, and (ii) controlling, by a phase modulator, a second quantum gate to cause the second quantum gate to adjust the state of the qubit based on the stabilized signal phase, wherein the second quantum gate is different than the first quantum gate.

In some embodiments, the first quantum gate includes an S-gate that is operable to adjust an amplitude of the state of the qubit, and the second quantum gate includes a U-gate that is operable to adjust a phase of the state of the qubit.

In some embodiments, (i) receiving the input analog signal includes receiving a continuous stream of analog data, and (ii) encoding the qubit to represent the conditioned analog signal includes continuously modifying a state of the qubit based on the continuous stream of analog data.

In some embodiments, generating the conditioned analog signal from the input analog signal includes (i) filtering the input analog signal, (ii) amplifying the input analog signal, and (iii) normalizing the input analog signal.

In some embodiments, the qubit that is encoded to store the continuous analog signal indicates the input analog signal without rounding errors and without sampling errors.

In some embodiments, the qubit is a register of qubits that includes at least two qubits, and encoding the qubit to represent the conditioned analog signal by storing the continuous analog signal includes encoding each qubit of the register of qubits with non-overlapping data based on a portion of the amplitude of the conditioned analog signal and a portion of the phase of the conditioned analog signal.

In some embodiments, the qubit is a register of qubits that includes at least two qubits. Additionally or alternatively, encoding the qubit to represent the conditioned analog signal by storing the continuous analog signal includes (i) encoding a first qubit of the register of qubits based on the amplitude of the conditioned analog signal and the phase of the conditioned analog signal and (ii) duplicating the first qubit to generate a second qubit of the register of qubits. Additionally or alternatively, the first qubit and the second qubit indicate identical data of the continuous analog signal.

In some embodiments, the method may additionally include providing the qubit that is encoded with the continuous analog signal to a downstream processing system that includes a qubit reader. Additionally or alternatively, the qubit reader is configured to read the qubit and configured to generate and/or provide instructions to a controller based at least in part on a state of the qubit defined by the encoded amplitude and the encoded phase.

The foregoing, together with other features and embodiments will become more apparent upon referring to the following specification, claims, and accompanying drawings.

### BRIEF DESCRIPTION OF THE DRAWINGS

FIG. 1 is a simplified diagram of a system that can be used to encode continuous analog data into a qubit based on a received continuous analog signal, according to at least one embodiment.

FIG. 2 is a simplified diagram of a spherical representation of a qubit that can include an encoded phase and an encoded amplitude based on a received continuous analog signal, according to at least one embodiment.

FIG. 3 is a simplified diagram of a process flow for using continuous analog data stored in an encoded qubit, according to at least one embodiment.

FIG. 4 is a simplified diagram of a process flow for using continuous analog data stored in a register of qubits, according to at least one embodiment.

FIG. 5 is a flowchart of a process for encoding a qubit with continuous analog data based on a received continuous analog signal, according to at least one embodiment.

FIG. 6 is a flowchart of a process for using continuous analog data encoded in a qubit based on a received continuous analog data signal, according to at least one embodiment.

FIG. 7 is a block diagram illustrating one pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Certain aspects and features of the present disclosure relate to quantum computing. For example, a quantum computing framework can be leveraged to represent continuous analog data using one or more qubits. In some embodiments, the quantum computing framework can mimic neuronal activity by representing data as graded potentials. The quantum computing framework can leverage the continuous amplitudes of qubits for more detailed and precise data representation. In some examples, and by using Quantum Fourier Transforms (QFT) for summation, and quantum measurements for adaptive threshold detection, techniques involving the quantum computing framework can preserve the nuances of continuous data such as without rounding errors, sampling errors, etc. The quantum computing framework can thus enable richer data representation, faster and more efficient computation, and more robust decision-making.

In some embodiments, the quantum computing framework can use, such as directly use, an amplitude of a qubit. As discussed here, “a qubit” may refer to one or more, or many, qubits. Unlike traditional quantum computing, which primarily relies on probabilities, techniques involving the quantum computing framework can leverage the continuous amplitude of a qubit for data representation and processing, which preserves nuanced details in the data. Additionally or alternatively, the quantum computing framework can use graded potentials representation. That is, the quantum computing framework can mimic neuronal graded potentials to provide a more detailed representation of continuous data while addressing the limitations of discrete data representation. QFT can be applied within the quantum computing framework to achieve efficient parallel summation of data, to enhance computational speed, to improve scalability, etc. In some embodiments, the quantum computing framework can use quantum measurements to perform threshold detection, which can mimic neuronal firing mechanisms and can enhance adaptability in decision-making processes. The quantum computing framework can significantly enhance the capabilities of quantum computing, which will have an impact across various industries and technical fields. For example, as applied to artificial intelligence and machine learning, improved data representation and processing based on the quantum computing framework will lead to more accurate models, better feature extraction, and enhanced decision-making. Additionally or alternatively, the quantum computing framework can enhance, such as via the more accurate models, the better feature extraction, and the enhanced decision-making, applications like autonomous driving, fraud detection, and image recognition, etc.

Many continuous analog signals may exist or otherwise be generated in various fields. In some embodiments, the analog signal may be configured to represent various real-world continuous concepts. For example, magnetic resonance imaging (MRI) data is generated and received as continuous analog data, signals based on electric current are generated and received as continuous analog data, etc. The generated analog data may be continuous such that the data is not generated at certain points in time and forms a continuum of data, lacking any discontinuous points, from a starting time to an optional ending time. Traditionally, receiving, storing, and using the continuous analog data involved taking point-in-time measurements of the continuous analog data to be able to store a digital representation (e.g., as ones and zeros or other binary representation) of the continuous analog data in a digital computing device. But, taking point-in-time measurements involves discarding some data included in the continuous analog data by discretizing or sampling the continuous analog data. Additionally, the digital computing devices typically do not have sufficient storage space to store infinitely many decimal points, so the discretized data is then rounded to be able to be stored and/or used by the digital computing device.

The techniques described herein, such as with respect to the quantum computing framework, provide a solution to the above problems. In particular, the techniques described herein may relate to storing continuous analog data based on a received continuous analog signal using a qubit. In some embodiments, the received continuous analog signal is a signal that varies continuously in amplitude and frequency over time and that can take any value within a predetermined range. As used herein, a qubit is a unit of storage for a quantum computing system. That is, the qubit, or quantum bit, may be or include a basic unit of information used in quantum computing systems. The qubit may be configured to store theoretically infinitely large amounts of data including continuous analog data. In some cases, the qubit may have an amplitude and a phase, represented by θ and φ, respectively, that can be used to store continuous analog data based, for example, on a received continuous analog signal. The techniques described herein involve, at least in part, encoding the amplitude and/or the phase of the qubit based on the received continuous analog signal. Additionally or alternatively, the encoded qubit, or a register of encoded qubits, can be duplicated, measured, or otherwise used to generate instructions for controlling a downstream operation such as generating an image, controlling a real-world machine (e.g., an autonomous car, etc.), and the like.

The techniques described herein provide improvements at least to the functionality of a computing device. For example, a traditional computing device, such as a digital computing device that uses binary code to store data, is required to discretize and/or round data included in a received analog signal to be able to store the received analog signal. By discretizing and/or rounding the data, some data is lost due to discretization and/or obscured by rounding errors. The techniques described herein do not suffer from the same drawbacks as do traditional computing devices. For example, the techniques described herein relate, at least in part, to storing continuous analog data by encoding a qubit such as by adjusting and/or stabilizing an amplitude or a phase thereof. The resulting encoded qubit does not have rounding errors, and encoding the qubit does not involve discretizing or sampling the continuous analog signal. Thus, the techniques described herein, and devices and/or systems, such as the quantum computing framework, that implement the techniques described herein, improve upon prior devices and/or systems that rely on traditional and/or conventional computing techniques.

Certain aspects and features of the present disclosure relate to encoding a qubit with continuous analog data based on a received continuous analog signal. A qubit can include or be a unit of information in a quantum computing device such as the quantum computing framework. The received continuous analog signal can be generated by a separate computing device, which may be or include an analog device, a digital device, a quantum device, or any combination thereof. In some cases, the received continuous analog signal may have infinitely many data points since the received continuous analog signal is a continuum of data between two points in time. As the data is received, or after the data is received, the qubit can be encoded with the continuous analog data that is based on the received continuous analog data signal. Encoding the qubit can involve adjusting characteristics of the qubit to cause the qubit to store the received continuous analog signal as the continuous analog data. In some embodiments, the characteristics of the qubit that can be adjusted to store the continuous analog data can include an amplitude and a phase. The amplitude and the phase may be similar or identical to, or may correspond with, the amplitude and the phase of the wave function of the qubit.

In some embodiments, encoding the qubit can involve adjusting or encoding the phase and the amplitude of the wave function of the qubit. The amplitude of the wave function of the qubit can be encoded using a first quantum gate of a quantum computing device, and the phase of the wave function of the qubit can be encoded using a second quantum gate of the quantum computing device. In some embodiments, the first quantum gate may be the U-gate or the Ry gate, and the second quantum gate may be the S-gate or the Rz gate, though other suitable gates, or a vice versa arrangements of gates, may be possible.

In some embodiments, the quantum computing framework may represent graded potentials, which may correspond to or be the amplitudes of continuous electrical signals or the amplitudes of other continuous analog signals, using the quantum states of a qubit. This can allow for more nuanced and flexible computational models compared to classical binary computing, similar to how the human brain processes data. The quantum computing framework may normalize the graded potentials to a range that is compatible with quantum operations. The quantum computing framework can initialize qubits to represent the normalized graded potentials using a first quantum gate such as the Ry gate. The first quantum gate can be used to rotate the qubit around the y-axis on the Bloch sphere to encode the continuous graded potential.

Additionally or alternatively, the quantum computing framework can adjust the phase of the qubit using a second quantum gate, such as the Rz gate, to encode additional information or refine the representation. Once the qubit has been initialized to represent graded potentials using the amplitude and phase encoding techniques described above, and in examples in which a register of qubits is used to represent the continuous analog signal, the quantum computing framework can use QFT to sum the amplitudes of the register of qubits. QFT can transform the superposition states of the register of qubits, summing their amplitudes analogous to neuronal synaptic integration. This leverages quantum parallelism, which can enable the simultaneous processing of multiple data points. After summing the register of qubits, the quantum computing framework can optionally perform a measurement to collapse the qubit states. The quantum computing framework can analyze the measurement results to determine if the cumulative amplitude exceeds a predefined threshold, similar to how neurons fire when the potential surpasses a certain level.

As used herein, a signal phase is a phase of a received continuous analog signal, and a signal amplitude is an amplitude of the received continuous analog signal. In some embodiments, the first quantum gate and/or the second quantum gate can be controlled by one or more modulators of one or more analog circuits of the quantum computing framework. The one or more modulators may include a first modulator, such as an amplitude modulator, and a second modulator such as a phase modulator. The amplitude modulator may receive a gain-adjusted analog signal, which may have an adjusted signal amplitude, and the amplitude modulator can control an operation of the first quantum gate, or the U-gate or Ry gate, to cause the amplitude of the qubit to be adjusted to correspond with the signal amplitude. In some embodiments, the qubit amplitude corresponding with the signal amplitude may involve the qubit amplitude being the same as the signal amplitude. In other embodiments, the bit amplitude corresponding with the signal amplitude may involve the qubit amplitude being encoded to be representative of the signal amplitude such that the qubit amplitude stores data that represents the signal amplitude but is not itself the signal amplitude.

In some embodiments, the second modulator, or the phase modulator, may receive a stabilized analog signal, which may have a stabilized phase, and the phase modulator can control an operation of the second quantum gate, or the S-gate or Rz gate, to cause the phase of the qubit to be adjusted to correspond with the signal phase. In some embodiments, the qubit phase corresponding with the signal phase may involve the qubit phase being the same as the signal phase. In other embodiments, the qubit phase corresponding with the signal phase may involve the qubit phase being representative of the signal phase such that the qubit phase stores data that represents the signal phase but is not itself the signal phase. In some embodiments, and instead of the qubit phase and the qubit amplitude separately storing and/or representing data associated with the signal phase and/or the signal amplitude, a combination of the qubit phase and the qubit amplitude may be representative of the data indicated by the signal phase and the signal amplitude.

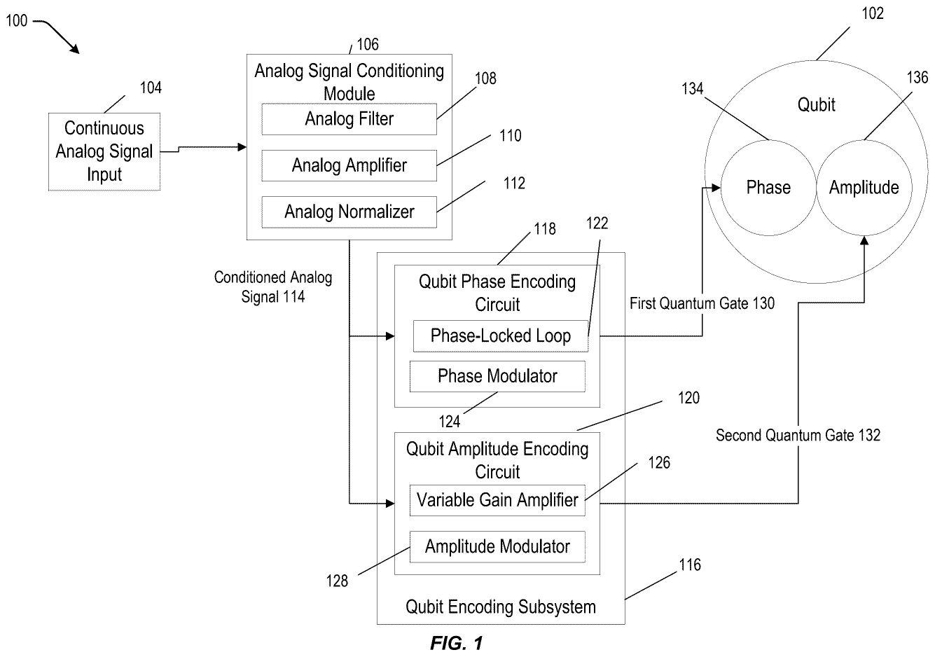

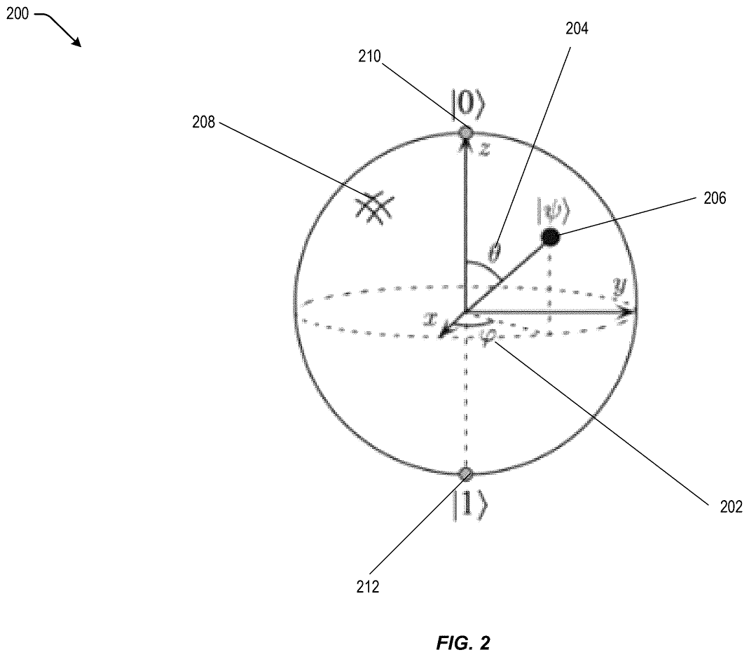

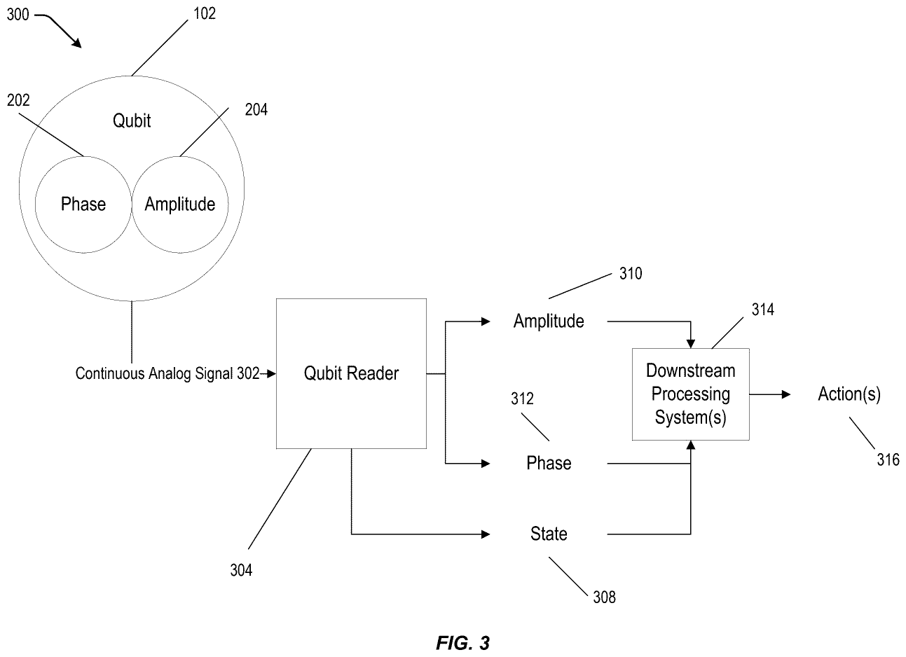

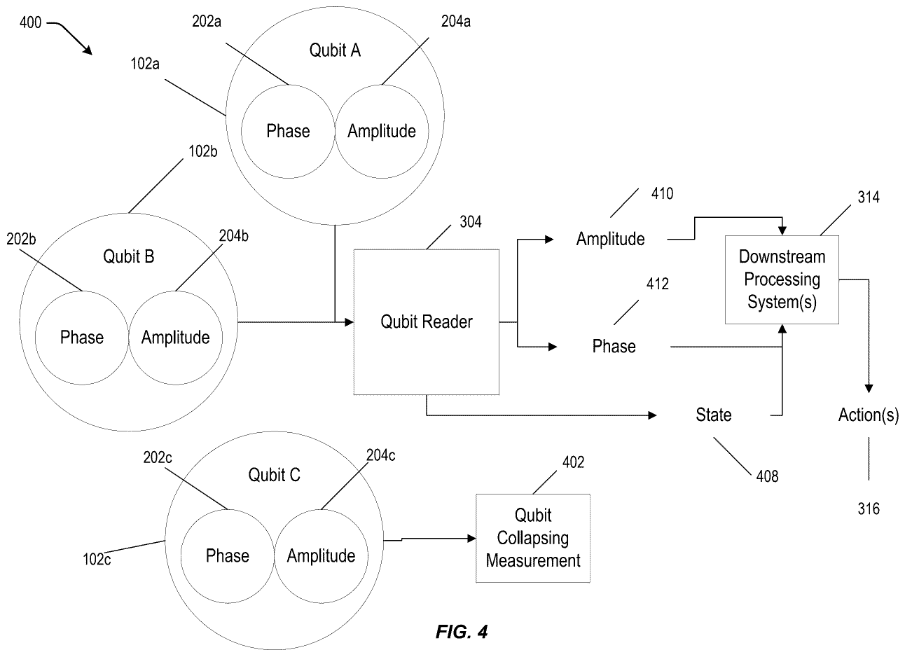

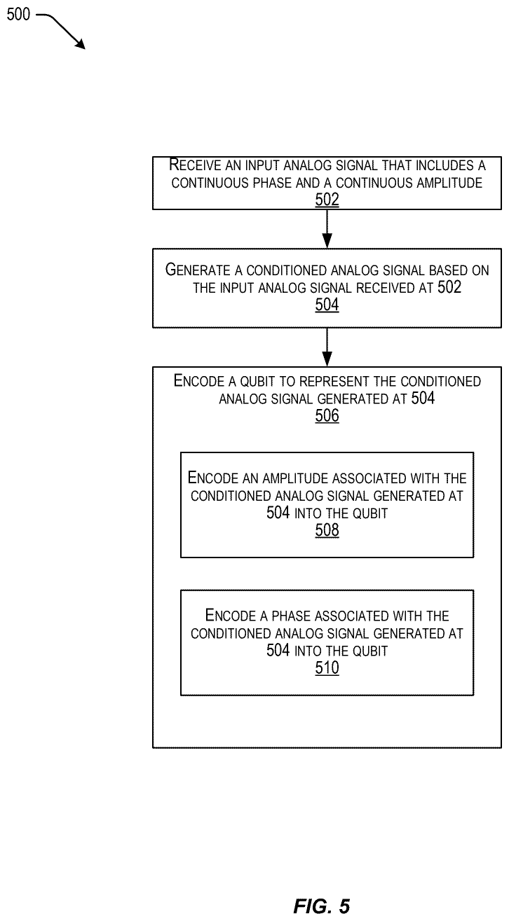

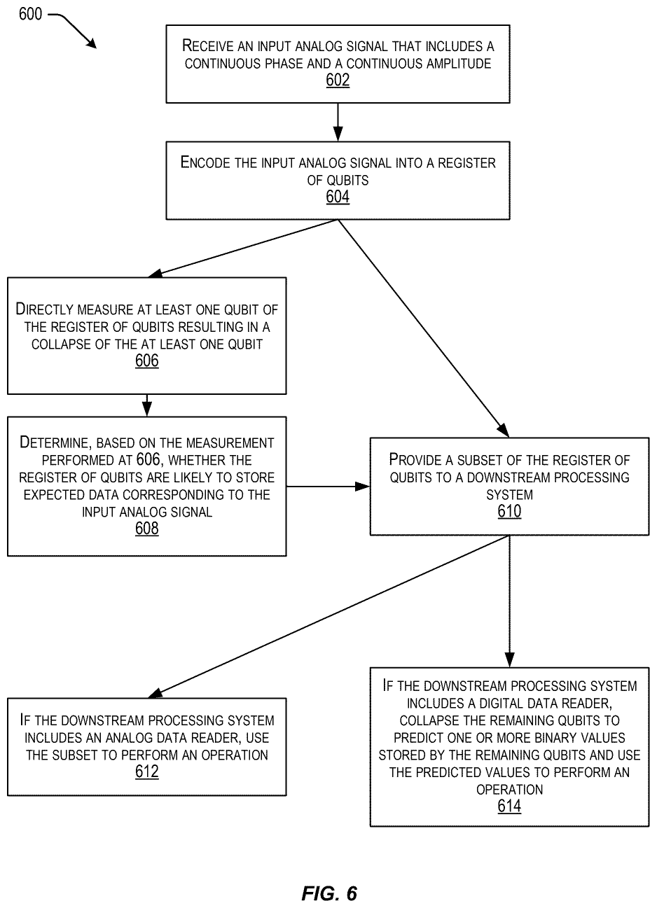

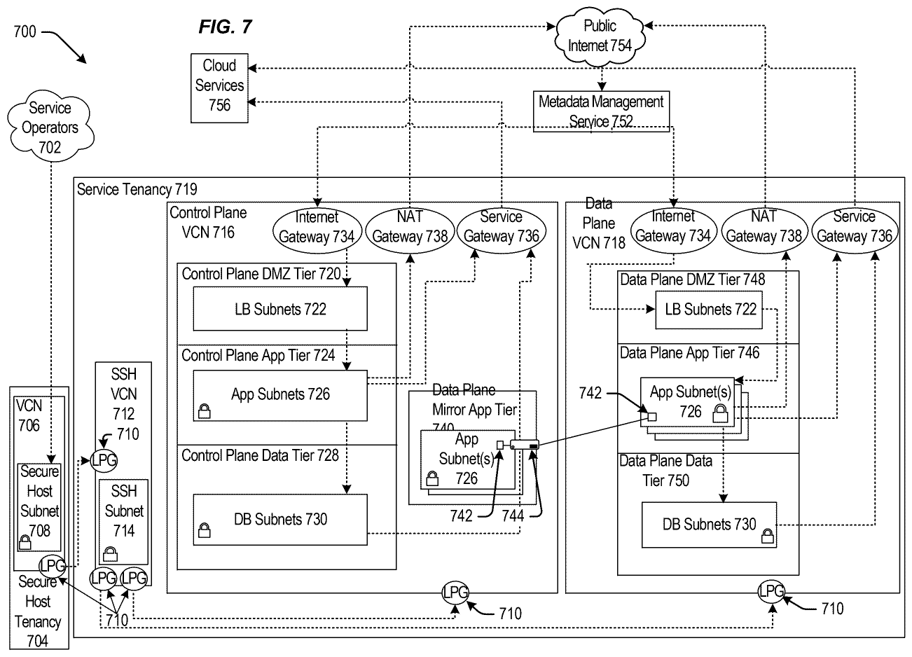

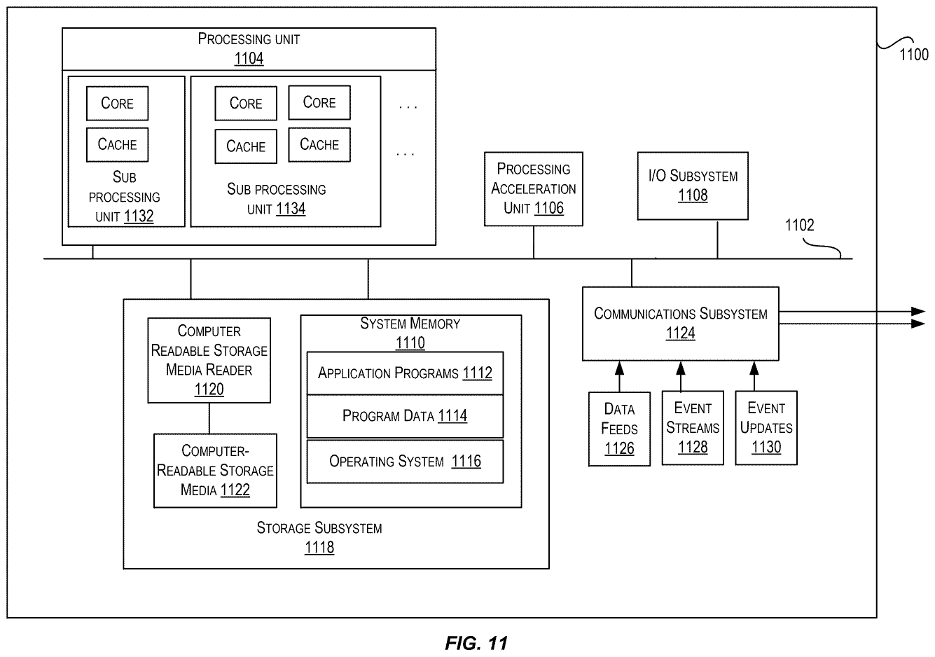

FIG. 1 illustrates and describes an example of a quantum computing framework for storing continuous analog data in a qubit. FIG. 2 is a simplified representation, such as a Bloch Sphere, of a qubit that can be encoded using a quantum computing framework. FIGS. 3-4 illustrate and describe techniques for using an encoded qubit, or registers thereof, using a quantum computing framework. FIGS. 5-6 illustrate and describe flowcharts representing processes that can be performed by a quantum computing framework with respect to a qubit and continuous analog data. FIGS. 7-10 depict examples of architectures for implementing cloud infrastructures for providing one or more cloud services, where the infrastructures may incorporate teachings described herein. FIG. 11 depicts a block diagram illustrating an example of a computer system or device, according to at least one embodiment.

### Novel Architecture for a Quantum Computing Framework

FIG. 1 is a simplified diagram of a quantum computing framework 100, or quantum computing system, that can be used to encode continuous analog data into a qubit 102 based on a received continuous analog signal 104, according to at least one embodiment. In some embodiments, the quantum computing framework 100 may be a portion of a quantum computing system that can use the quantum computing framework 100 to encode and/or use the qubit 102 based on the received continuous analog signal 104. As discussed herein, the qubit 102 may include a single qubit, which is a single unit of information in quantum computing, or the qubit 102 illustrated in FIG. 1 may represent a register of qubits that can include more than one single qubit. The register of qubits can include multiple qubits used to capture different, or partially overlapping or non-overlapping, data relating to a continuous analog signal such as the received continuous analog signal 104. In some embodiments, the register of qubits can include multiple qubits generated, such as by via duplication or copying, via a single qubit encoded based on a continuous analog signal such as the received continuous analog signal 104.

The received continuous analog signal 104 may include continuous data such as a continuous electrical signal that can vary in amplitude from a first point in time to a second point in time. In some embodiments, at least the second point in time may be variable such as the present (e.g., the second point in time may be unbound). The received continuous analog signal 104 may be received by the quantum computing framework 100 via an analog signal conditioning module 106. The analog signal conditioning module 106 may be configured to process, or pre-process, the received continuous analog signal 104 prior to using the received continuous analog signal 104 for encoding the qubit 102.

As illustrated in FIG. 1, the analog signal conditioning module 106 can include an analog filter 108, an analog amplifier 110, and an analog normalizer 112. In some embodiments, the analog signal conditioning module 106 can include any additional, alternative, or fewer components for generating a conditioned analog signal 114 based on the received continuous analog signal 104. Additionally or alternatively, while the conditioned analog signal 114 may be a conditioned version of the received continuous analog signal 104, the conditioned analog signal 114 may also be continuous in nature. The analog filter 108 may clean the received continuous analog signal 104 before the received continuous analog signal 104 is processed. For example, the analog filter 108 may remove unwanted noise or frequencies from the received continuous analog signal 104 that could interfere with encoding the qubit 102. The analog amplifier 110 may boost, such as increase, a strength of the received continuous analog signal 104. The analog amplifier 110 may increase the strength, such as an amplitude, of the received continuous analog signal 104 to ensure that the received continuous analog signal 104 is strong enough to be used in subsequent stages of processing involving the quantum computing framework 100. That is, the conditioned analog signal 114 may include a signal strength above a threshold signal strength for influencing the qubit 102. The analog normalizer 112 may adjust the amplitude of the received continuous analog signal 104 to fit within a specific range that a quantum computer or computing system implementing the quantum computing framework 100 can handle or otherwise process. The output of the analog signal conditioning module 106 includes the conditioned analog signal 114, which includes one or more signal amplitudes and one or more signal phases.

The conditioned analog signal 114 is output by the analog signal conditioning module 106 and provided to a qubit encoding subsystem 116 of the quantum computing framework 100. As illustrated in FIG. 1, the qubit encoding subsystem 116 can include a qubit phase encoding circuit 118 and a qubit amplitude encoding circuit 120, though additional, alternative, or fewer components are possible to include in the qubit encoding subsystem 116. The qubit phase encoding circuit 118 can include a phase-locked loop 122 and a phase modulator 124, though additional, alternative, or fewer components are possible to include in the qubit phase encoding circuit 118. The phase-locked loop 122 may ensure that the signal phase of the conditioned analog signal 114 is stable and can be accurately transferred to the qubit 102. In some embodiments, the phase-locked loop 122 may lock onto the signal phase and may keep the signal phase steady. The phase modulator 124 may receive the stable signal phase from the phase-locked loop 122 and may use the stable signal phase to control, such as via direct control, the phase of the qubit 102. In some embodiments, the phase modulator 124 may ensure that the phase of the qubit 102 mirrors the signal phase from the conditioned analog signal 114.

The qubit amplitude encoding circuit 120 can include a variable gain amplifier 126 and an amplitude modulator 128. The variable gain amplifier 126 may adjust the signal amplitude of the conditioned analog signal 114 in a controlled way, which can allow the qubit amplitude encoding circuit 120 to fine-tune how much influence the conditioned analog signal 114, or the amplitude thereof, will have on the state of the qubit 102. The amplitude modulator 128 may receive output from the variable gain amplifier 126 and may use the output to control the amplitude of the state of the qubit 102. In some embodiments, the amplitude modulator 128 and the phase modulator 124 may use one or more quantum gates to adjust and/or encode the state of the qubit 102. In some embodiments, the state of the qubit 102 may include or be defined by a phase 134 and an amplitude 136. Additionally or alternatively, the qubit 102 may be or include a superconducting qubit that can have the state influenced by the signal phase and the signal amplitude of the conditioned analog signal 114, allowing the qubit 102 to be used for performing quantum computations based on continuous data.

The one or more quantum gates may include a first quantum gate 130 and a second quantum gate 132. In some embodiments, the first quantum gate 130 may be used by the phase modulator 124 to adjust or encode the phase 134 of the state of the qubit 102, and the second quantum gate 132 may be used by the amplitude modulator 128 to adjust or encode the amplitude 136 of the state of the qubit 102, though a vice versa arrangement is possible. In some embodiments, the first quantum gate 130 may be or include the U-gate or the Rz gate that is operable to adjust or encode the phase 134 of the state of the qubit 102, and the second quantum gate 132 may be or include the S-gate or the Ry gate that is operable to adjust or encode the amplitude 136 of the state of the qubit 102.

While illustrated in FIG. 1 as a single qubit, the qubit 102 may include a register of qubits. The register of qubits can include two or more qubits that may be (i) identical to one another (e.g., duplicated from a single qubit and having at least approximately identical states, phases, and amplitudes) or (ii) different from one another and generated based on the conditioned analog signal 114 (e.g., each qubit of the register of qubits may encode a different portion of the conditioned analog signal 114, and a union of data represented by the register of qubits may correspond with the conditioned analog signal 114).

### Example of a Spherical Representation of a Qubit

FIG. 2 is a simplified diagram of a spherical representation 200 of a qubit 102 that can include an encoded phase 202 and an encoded amplitude 204 based on a received continuous analog signal 104, according to at least one embodiment. As illustrated in FIG. 2, the spherical representation 200 may be similar or identical to a Bloch Sphere. The spherical representation 200 includes two different angle measurements, θ and φ, for a state 206 of the qubit 102. The state 206 exists on a surface 208 of the spherical representation 200, and the two different angle measurements, θ and φ, determine where on the surface 208 of the spherical representation 200 the state 206 exists. In some embodiments, the state, ψ, can be defined as

$$ψ = cos ( \frac{θ}{2} ) \vert 0 〉 + {e}^{i ϕ} sin ( \frac{θ}{2} ) \vert 1 〉 .$$

Additionally or alternatively, there may be infinitely many locations on the surface 208 of the spherical representation 200 that the state 206 may exist.

As illustrated in FIG. 2, the spherical representation 200 includes a first binary value 210 and a second binary value 212 that may correspond to a 0 and a 1, respectively, in digital computing. That is, if the value for θ is 0, π, or any multiple thereof, the state 206 may collapse to, or otherwise take the value of, either the first binary value 210 or the second binary value 212. In some embodiments, the state 206 of the qubit 102 may be or include a superposition of the first binary value 210 and the second binary value 212.

In some embodiments, the two different angle measurements, θ and φ, correspond with the encoded phase 202 and the encoded amplitude 204 of the qubit 102. For example, θ may correspond with, or be, the encoded amplitude 204, and φ may correspond with, or be, the encoded phase 202. The encoded phase 202 may be or include the phase 134 of the state of the qubit 102 after being modulated by the phase modulator 124 such as via the first quantum gate 130. Additionally or alternatively, the encoded amplitude 204 may be or include the amplitude 136 of the state of the qubit 102 after being modulated by the amplitude modulator 128 such as via the second quantum gate 132.

### Novel Architecture for a Quantum Computing Framework and Using an Encoded Qubit

FIG. 3 is a simplified diagram of a process flow for using continuous analog data stored in an encoded qubit, according to at least one embodiment. The qubit 102 may include a single qubit or a register of qubits that may be duplicates of one another or may collectively store data associated with the conditioned analog signal 114. As illustrated in FIG. 3, the qubit 102 is an encoded qubit that includes a modulated phase 202 and a modulated amplitude 204. The modulated phase 202 may include a phase of the state of the qubit 102 that has been modulated or otherwise interacted with by the phase modulator 124 such as via the first quantum gate 130. Additionally or alternatively, the modulated amplitude 204 may include an amplitude of the state of the qubit 102 that has been modulated or otherwise interacted with by the amplitude modulator 128 such as via the second quantum gate 132. The state of the encoded qubit, such as via the modulated phase 202 and the modulated amplitude 204, may store a continuous analog signal 302 that can correspond with the conditioned analog signal 114.

As illustrated in FIG. 3, the qubit 102 is communicatively coupled with a qubit reader 304, and the qubit reader 304 can receive the continuous analog signal 302 from the qubit 102. In some embodiments, the qubit reader 304 may be or include an analog data reader that is configured to interact with or otherwise communicate with the qubit 102 to read out the continuous analog signal 302. That is, the qubit reader 304 may be configured to read out the state 308 of the qubit 102, a measured amplitude 310 of the qubit 102, a measured phase 312 of the qubit 102, any other suitable information relating to the qubit 102, or any combination thereof. The qubit reader 304 may read out the continuous analog signal 302 as an output continuous analog signal. For example, the qubit reader 304 may be configured to read the qubit 102, or the state 308, amplitude 310, phase 312, etc., thereof and to produce the continuous analog signal 302 without losing data via data rounding, data sampling, etc.

In some embodiments, the qubit reader 304 may be or include a digital data reader that is configured to interact with or otherwise communicate with the qubit 102 to collapse the state 308 of the qubit 102 based on one or more probabilities associated with the amplitude 310 and/or the phase 312 of the state 308 of the qubit 102. That is, the qubit reader 304 may be configured to directly read the state 308 of the qubit 102, the amplitude 310 of the qubit 102, the phase 312 of the qubit 102, any other suitable information relating to the qubit 102, to cause the qubit 102 to take one of two binary values similar to a digital computing device. The probabilities associated with the state 308 of the qubit 102 may influence whether the collapsed state of the qubit 102 takes a 0 or a 1 value. The qubit reader 304 may read out the approximated state as one or more digital data points. In some embodiments, such as in examples in which the qubit 102 is a register of qubits, QFT can be used to sum the amplitudes of the register of qubits. QFT can transform the superposition states of the register of qubits, summing their amplitudes to leverage quantum parallelism, which can enable the simultaneous processing of multiple data points. After summing the register of qubits, a measurement can be performed on the qubit 102, and the measurement results can be analyzed to determine if the cumulative amplitude exceeds a predefined threshold.

An output of the qubit reader 304 can be provided to a downstream processing system 314. In some embodiments, the output of the qubit reader 304 can include the continuous analog signal 302, can include the state 308 of the qubit 102, can include the amplitude 310 and/or the phase 312 of the qubit 102, can include an estimation of the state 308 of the qubit 102 after a measurement of the qubit 102, or any combination thereof. The downstream processing system 314 may receive the output and may use the output to generate one or more actions 316 that can be taken based at least in part on the output. The one or more actions 316 can be performed by the downstream processing system 314, instructions for the one or more actions 316 can be generated by the downstream processing system 314, or a combination thereof. For example, the downstream processing system 314 may generate instructions for performing the one or more actions 316, and either (i) the downstream processing system 314 may execute the instructions, or (ii) the downstream processing system 314 may transmit the instructions to a separate computing system, whether quantum, digital, analog, etc., for executing the instructions.

In some embodiments, the downstream processing system can be, can include, or can be associated with different real-world applications and/or practical applications. The different real-world applications and/or practical applications can include autonomous driving, medical image, and other suitable real-world applications and/or practical applications. With respect to autonomous driving, the downstream processing system 314 can include a control module on an autonomous vehicle that is configured to read the continuous analog signal 302 from the qubit 102 and generate control instructions for controlling a trajectory of the autonomous vehicle. Additionally or alternatively, and with respect to medical imaging, the downstream processing system 314 can include a detection module that is configured to read the continuous analog signal 302 from the qubit 102 and provide analysis regarding medical images, such as an MRI image, that a human, or even a traditional computing system, would be unable to perform.

FIG. 4 is a simplified diagram of a process flow for using continuous analog data stored in a register of qubits 400, according to at least one embodiment. As illustrated in FIG. 4, the register of qubits 400 can include three qubits: a first qubit 102a, a second qubit 102b, and a third qubit 102c, though any other suitable number (e.g., less than three or more than three) of qubits is possible to include in the register of qubits 400. In some embodiments, the first qubit 102a, the second qubit 102b, and the third qubit 102c may be similar or identical to one another such as by each having a similar or identical state. In other embodiments, the first qubit 102a, the second qubit 102b, and the third qubit 102c may be collectively used to store the continuous analog signal 302 in which the first qubit 102a stores a first portion of the continuous analog signal 302, the second qubit 102b stores a second portion of the continuous analog signal 302, and the third qubit 102c stores a third portion of the continuous analog signal 302. The first qubit 102a, the second qubit 102b, and the third qubit 102c can each have a phase (phase 202a, phase 202b, and phase 202c, respectively) and an amplitude (e.g., amplitude 204a, amplitude 204b, and amplitude 204c, respectively), which may represent the modulated or encoded versions (e.g., stored via the qubit) of the phase and amplitude of the respective qubit.

The register of qubits 400 can be used for various purposes. For example, a particular qubit, such as the third qubit 102c, of the register of qubits 400 can be measured, such as at qubit collapsing measurement 402, to cause the particular qubit to collapse into a particular binary state, for example to determine whether the register of qubits 400 stores expected data such as data corresponding with the conditioned analog signal 114. Additionally or alternatively, one or more qubits, such as the first qubit 102a and the second qubit 102b, of the register of qubits 400 can be communicatively coupled with the qubit reader 304. The qubit reader 304 may be configured to receive a continuous analog signal from the first qubit 102a and the second qubit 102b. The continuous analog signal may be or include the continuous analog signal 302, may be a portion of the continuous analog signal 302, etc. based on how the register of qubits 400 was encoded with data according to the conditioned analog signal 114.

The qubit reader 304 can receive the continuous analog signal from the first qubit 102a and the second qubit 102b. In some embodiments, the qubit reader 304 may be or include an analog data reader that is configured to interact with or otherwise communicate with at least a subset of the register of qubits 400 to read out the continuous analog signal. That is, the qubit reader 304 may be configured to read out a state 408 of each qubit of the subset of the register of qubits 400, a measured amplitude 410 of each qubit of the subset of the register of qubits 400, a measured phase 412 of each qubit of the subset of the register of qubits 400, any other suitable information relating to each qubit of the subset of the register of qubits 400, or any combination thereof. The qubit reader 304 may read out the continuous analog signal as an output continuous analog signal. For example, the qubit reader 304 may be configured to read the subset of the register of qubits 400, or the state 408, amplitude 410, phase 412, etc., thereof and to produce the continuous analog signal without losing data via data rounding, data sampling, etc.

In some embodiments, the qubit reader 304 may be or include a digital data reader that is configured to interact with or otherwise communicate with each qubit of the subset of the register of qubits 400 to collapse the state 408 of each qubit of the subset of the register of qubits 400 based on one or more probabilities associated with the amplitude 410 and/or the phase 412 of the state 408. That is, the qubit reader 304 may be configured to directly read the state 408, the amplitude 410, the phase 412, any other suitable information relating to the subset of the register of qubits 400, to cause the continuous analog signal to approximate one of two binary values similar to a digital computing device. The probabilities associated with the state 408 may influence whether the collapsed state of the subset of the register of qubits 400 takes a 0 or a 1 value. The qubit reader 304 may read out the approximated state as one or more digital data points. In some embodiments, QFT can be used to sum the amplitudes of the subset of the register of qubits 400. QFT can transform the superposition states of the subset of the register of qubits 400, summing their amplitudes to leverage quantum parallelism, which can enable the simultaneous processing of multiple data points. After summing the subset of the register of qubits 400, a measurement can be performed on the subset of the register of qubits 400, and the measurement results can be analyzed to determine if the cumulative amplitude exceeds a predefined threshold.

An output of the qubit reader 304 can be provided to a downstream processing system 314. In some embodiments, the output of the qubit reader 304 can include the continuous analog signal, can include the state 408, can include the amplitude 410 and/or the phase 412, can include an estimation of the state 408 after a measurement, or any combination thereof. The downstream processing system 314 may receive the output and may use the output to generate one or more actions 316 that can be taken based at least in part on the output. The one or more actions 316 can be performed by the downstream processing system 314, instructions for the one or more actions 316 can be generated by the downstream processing system 314, or a combination thereof. For example, the downstream processing system 314 may generate instructions for performing the one or more actions 316, and either (i) the downstream processing system 314 may execute the instructions, or (ii) the downstream processing system 314 may transmit the instructions to a separate computing system, whether quantum, digital, analog, etc., for executing the instructions.

In some embodiments, the downstream processing system can be, can include, or can be associated with different real-world applications and/or practical applications. The different real-world applications and/or practical applications can include autonomous driving, medical image, and other suitable real-world applications and/or practical applications. With respect to autonomous driving, the downstream processing system 314 can include a control module on an autonomous vehicle that is configured to read the continuous analog signal from the subset of the register of qubits 400 and generate control instructions for controlling a trajectory of the autonomous vehicle. Additionally or alternatively, and with respect to medical imaging, the downstream processing system 314 can include a detection module that is configured to read the continuous analog signal and provide analysis regarding medical images, such as an MRI image, that a human, or even a traditional computing system, would be unable to perform.

### Novel Processes for Using a Quantum Computing Framework

FIG. 5 is a flowchart of a process 500 for encoding a qubit 102 with continuous analog data based on a received continuous analog signal 104, according to at least one embodiment.

At 502, an input analog signal, such as the received continuous analog signal 104, is received. In some embodiments, the input analog signal is received as a continuous stream of analog data. In other embodiments, the input analog signal may be received in chunks or otherwise not as a stream. The input analog signal may be or include a signal that varies continuously in amplitude and frequency over time and can take any value within a predetermined range, which may be determined or adjusted by the quantum computing framework. For example, the analog signal conditioning module 106 may adjust the absolute values of the frequency and/or the amplitude of the input analog signal to cause the input analog signal to take values within the predetermined range.

At 504, a conditioned analog signal, such as the conditioned analog signal 114, is generated. In some embodiments, the conditioned analog signal 114 can be generated by the analog signal conditioning module 106. For example, the analog signal conditioning module 106 may filter the input analog signal, may amplify the input analog signal, may normalize the input analog signal, or any combination thereof to generate the conditioned analog signal 114 based on the input analog signal. The conditioned analog signal 114 may include an amplitude and a phase that can be identified and/or used for encoding the qubit 102.

At 506, the qubit 102 is encoded based on the conditioned analog signal 114 and according to the phase and the amplitude of the conditioned analog signal 114. The encoded qubit may be configured to store continuous analog data that corresponds with the conditioned analog signal 114, the input analog signal, or a combination thereof. In some embodiments, the qubit 102 can be continuously modified or continuously encoded based on a stream of input analog data in examples in which the input analog data is received as a stream. That is, as the input analog data is coming into the quantum computing framework, the input analog data can be conditioned and encoded in real-time into the qubit 102. The qubit 102 that is encoded to store the continuous analog signal may indicate the input analog signal, or the conditioned analog signal 114, without rounding errors and without sampling errors. In some embodiments, encoding the qubit 102 can be performed according to 508 and 510, as described below.

At 508, an amplitude associated with the conditioned analog signal 114 is encoded into the qubit 102. In some embodiments, encoding the amplitude associated with the conditioned analog signal 114 into the qubit 102 can include adjusting, such as by using a variable gain amplifier 126, the amplitude associated with the conditioned analog signal 114 to generate an adjusted signal amplitude. Additionally or alternatively, encoding the amplitude associated with the conditioned analog signal 114 into the qubit 102 can include controlling, such as by an amplitude modulator 128, a first quantum gate 130 to cause the first quantum gate 130 to adjust a state of the qubit 102 based on the adjusted signal amplitude. The first quantum gate 130 can be or include an S-gate, an Ry gate, or other suitable quantum gate that is operable to control the amplitude of the state of the qubit 102.

At 510, a phase associated with the conditioned analog signal 114 is encoded into the qubit 102. In some embodiments, encoding the phase associated with the conditioned analog signal 114 into the qubit 102 can include adjusting, using a phase-locked loop 122, the phase associated with the conditioned analog signal 114 to generate a stabilized signal phase. Additionally or alternatively, encoding the phase associated with the conditioned analog signal 114 into the qubit 102 can include controlling, by a phase modulator 124, a second quantum gate 132 to cause the second quantum gate 132 to adjust the state of the qubit 102 based on the stabilized signal phase. The second quantum gate 132 may be different than the first quantum gate 130. For example, the first quantum gate 130 may be or include the S-gate or the Ry gate, the second quantum gate 132 may be or include a U-gate or an Rz gate.

In some embodiments, the process 500 can additionally include providing the qubit 102 that is encoded with the continuous analog signal to a downstream processing system 314 that includes or is communicatively coupled with a qubit reader 304. The qubit reader 304 may be configured to read the qubit 102 and may be configured to generate and/or provide instructions to a controller based at least in part on a state of the qubit defined by the encoded amplitude and the encoded phase. In some embodiments, the qubit reader 304 may digitally read the qubit 102 such as by directly measuring the state of the qubit 102 to cause the qubit 102 to collapse into a binary value that is an estimate of the data stored in the qubit 102. In other embodiments, the qubit reader 304 may read the continuous analog data stored in the qubit 102 and provide the continuous analog data to an analog controller.

FIG. 6 is a flowchart of a process 600 for using continuous analog data encoded in a qubit based on a received continuous analog data signal, according to at least one embodiment.

At 602, an input analog signal, such as the received continuous analog signal 104, is received. In some embodiments, the input analog signal is received as a continuous stream of analog data. In other embodiments, the input analog signal may be received in chunks or otherwise not as a stream. The input analog signal may be or include a signal that varies continuously in amplitude and frequency over time and can take any value within a predetermined range, which may be determined or adjusted by the quantum computing framework. For example, the analog signal conditioning module 106 may adjust the absolute values of the frequency and/or the amplitude of the input analog signal to cause the input analog signal to take values within the predetermined range.

At 604, a register of qubits 400 is encoded using the input analog signal received at 602. In some embodiments, the register of qubits 400 is encoded according to the process 500 described with respect to FIG. 5. For example, the input analog signal can be conditioned, processed, encoded, etc. using the qubit encoding subsystem 116 or any component or circuit thereof. In some embodiments, each qubit of the register of qubits 400 may be encoded with a different portion of the input analog signal. In other embodiments, a first qubit of the register of qubits 400 can be encoded with the input analog signal and duplicated to form a second qubit, a third qubit, and so on for the register of qubits 400. The register of qubits 400 may include qubits with overlapping data, partially overlapping data, or non-overlapping data.

At 606, at least one qubit of the register of qubits 400 is measured. In some embodiments, the at least one qubit may be directly measured, such as via measuring the state of the at least one qubit, and the measurement may cause the at least one qubit to collapse into a binary value that represents an estimation of the data stored by the at least one qubit. In other embodiments, the at least one qubit may include more than one qubit, and a quantum Fourier transform operation can be performed to estimate the amplitude of the more than one qubit. A result of the quantum Fourier transform operation can include an estimated amplitude.

At 608, the measurement performed at 606 is used to determine whether data stored by the register of qubits 400 corresponds with the input analog data. For example, the binary value, the estimated amplitude, or a combination thereof can be compared to a threshold value, such as a threshold binary value or a threshold amplitude value, to make a determination as to whether the register of qubits 400 was correctly or suitably encoded with data corresponding with the input analog data.

At 610, and based at least in part on the determination made at 608, a subset of the register of qubits 400, which may include all of the qubits of the register of qubits 400 or less than all of the qubits of the register of qubits 400, is provided to a downstream processing system 314. In some embodiments, the downstream processing system 314 may include or may be communicatively coupled with a qubit reader 304 that is configured to read data from the subset of the register of qubits 400. The qubit reader 304 may digitally read data from the subset of the register of qubits 400 or may read the continuous analog data from the subset of the register of qubits 400.

At 612, and in examples in which the qubit reader 304 includes an analog data reader, the subset of the register of qubits 400 is provided to the downstream processing system 314 for controlling an operation. Providing the subset of the register of qubits 400 can include extracting the continuous analog data stored by the subset of the register of qubits 400 and using the extracted continuous analog data to generate control instructions for controlling the operation. In some embodiments, the operation may include altering a trajectory of an intended path of an autonomous vehicle, may include altering machinery configured to generate medical images to optimize the medical images, etc.

At 614, and in examples in which the qubit reader 304 includes a digital data reader, the subset of the register of qubits 400 is provided to the downstream processing system 314 for controlling an operation. Providing the subset of the register of qubits 400 can include directly measuring or otherwise estimating the state of the register of qubits 400. This measurement or estimation may cause the register of qubits 400 to collapse into one or more digital data points or predictions of the continuous analog data stored by the register of qubits 400. The predictions of the continuous analog data stored by the register of qubits 400 can be used to generate control instructions for controlling the operation. In some embodiments, the operation may include altering a trajectory of an intended path of an autonomous vehicle, may include altering machinery configured to generate medical images to optimize the medical images, etc.

### Examples of Architectures for Implementing Cloud Infrastructures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may need to be set up first. In some instances, the provisioning can be done manually, a provisioning tool may be utilized to provision the resources, and/or deployment tools may be utilized to deploy the code once the infrastructure is provisioned.

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

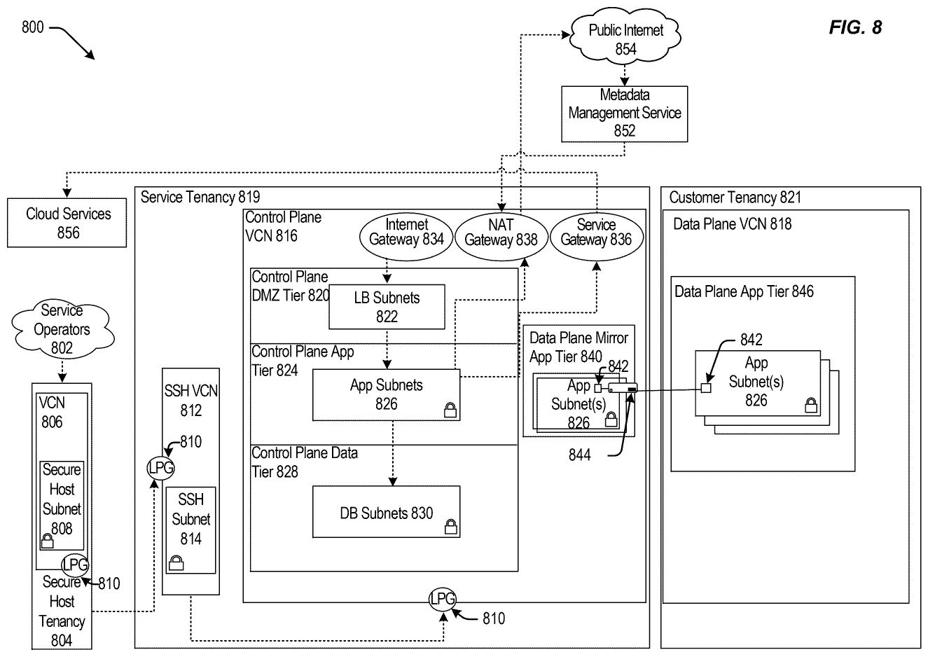

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 5,” may be located in Region 1 and in “Region 2.” If a call to Deployment 5 is made by the service gateway 836 contained in the control plane VCN 816 located in Region 1, the call may be transmitted to Deployment 5 in Region 1. In this example, the control plane VCN 816, or Deployment 5 in Region 1, may not be communicatively coupled to, or otherwise in communication with, Deployment 5 in Region 2.

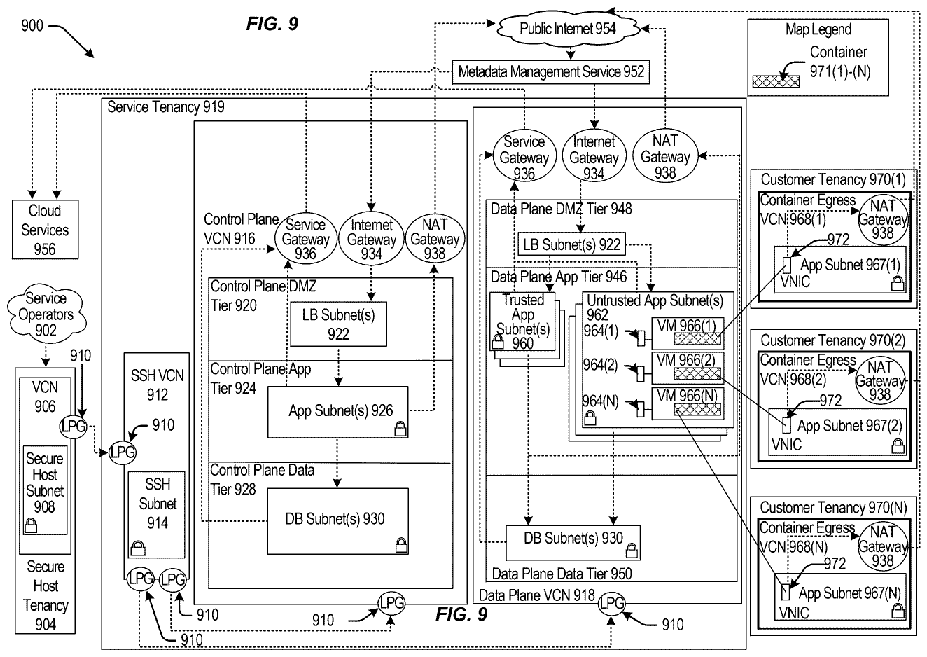

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

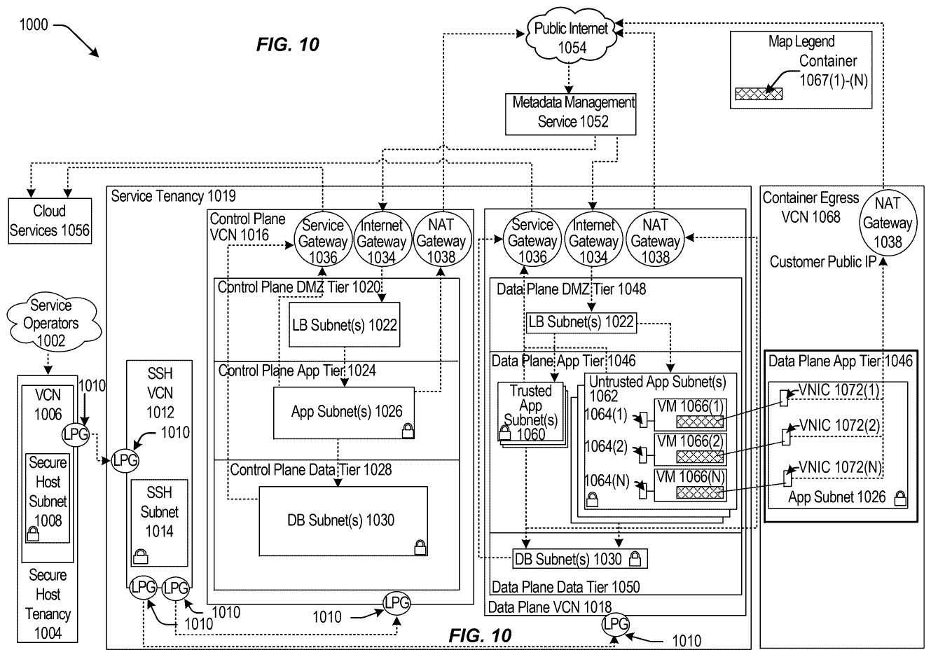

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

### Example of a Computer System or Device

FIG. 11 illustrates an example computer system 1100, in which various embodiments may be implemented. The system 1100 may be used to implement any of the computer systems and processing systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some, or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments provides an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method comprising:
receiving an input analog signal, wherein the input analog signal is a signal that varies continuously in amplitude and frequency over time and can take any value within a predetermined range;
generating a conditioned analog signal from the input analog signal; and
encoding a qubit to represent the conditioned analog signal by storing a continuous analog signal, wherein encoding the qubit comprises:
encoding an amplitude associated with the conditioned analog signal into the qubit, and
encoding a phase associated with the conditioned analog signal into the qubit.

2. The method of claim 1, wherein encoding the amplitude associated with the conditioned analog signal into the qubit comprises:
adjusting, using a variable gain amplifier, the amplitude associated with the conditioned analog signal to generate an adjusted signal amplitude; and
controlling, by an amplitude modulator, a first quantum gate to cause the first quantum gate to adjust a state of the qubit based on the adjusted signal amplitude.

3. The method of claim 2, wherein encoding the phase associated with the conditioned analog signal into the qubit comprises:
adjusting, using a phase-locked loop, the phase associated with the conditioned analog signal to generate a stabilized signal phase; and
controlling, by a phase modulator, a second quantum gate to cause the second quantum gate to adjust the state of the qubit based on the stabilized signal phase, wherein the second quantum gate is different than the first quantum gate.

4. The method of claim 3, wherein the first quantum gate comprises an S-gate that is operable to adjust an amplitude of the state of the qubit, and wherein the second quantum gate comprises a U-gate that is operable to adjust a phase of the state of the qubit.

5. The method of claim 1, wherein:
receiving the input analog signal comprises receiving a continuous stream of analog data; and
encoding the qubit to represent the conditioned analog signal comprises continuously modifying a state of the qubit based on the continuous stream of analog data.

6. The method of claim 1, wherein generating the conditioned analog signal from the input analog signal comprises (i) filtering the input analog signal, (ii) amplifying the input analog signal, and (iii) normalizing the input analog signal.

7. The method of claim 1, wherein the qubit that is encoded to store the continuous analog signal indicates the input analog signal without rounding errors and without sampling errors.

8. The method of claim 1, wherein the qubit is a register of qubits that comprises at least two qubits, and wherein encoding the qubit to represent the conditioned analog signal by storing the continuous analog signal comprises encoding each qubit of the register of qubits with non-overlapping data based on a portion of the amplitude of the conditioned analog signal and a portion of the phase of the conditioned analog signal.

9. The method of claim 1, wherein the qubit is a register of qubits that comprises at least two qubits, wherein encoding the qubit to represent the conditioned analog signal by storing the continuous analog signal comprises (i) encoding a first qubit of the register of qubits based on the amplitude of the conditioned analog signal and the phase of the conditioned analog signal and (ii) duplicating the first qubit to generate a second qubit of the register of qubits, and wherein the first qubit and the second qubit indicate identical data of the continuous analog signal.

10. The method of claim 1, further comprising providing the qubit that is encoded with the continuous analog signal to a downstream processing system that comprises a qubit reader, wherein the qubit reader is configured to read the qubit and configured to generate and/or provide instructions to a controller based at least in part on a state of the qubit defined by the encoded amplitude and the encoded phase.

11. A system comprising:
a qubit; and
a qubit encoding subsystem communicatively coupled with the qubit, the qubit encoding subsystem comprising:
a qubit phase encoding circuit configured to receive a conditioned analog signal and to encode a phase associated with the conditioned analog signal into the qubit, wherein the conditioned analog signal is based on an input analog signal that is a signal that varies continuously in amplitude and frequency over time and can take any value within a predetermined range; and
a qubit amplitude encoding circuit configured to received the conditioned analog signal and to encode an amplitude associated with the conditioned analog signal into the qubit, wherein the qubit encoded with the phase associated with the conditioned analog signal and with the amplitude associated with the conditioned analog signal is configured to store a continuous analog signal that indicates the conditioned analog signal.

12. The system of claim 11, wherein the qubit amplitude encoding circuit comprises:
a variable gain amplifier that is configured to adjust the amplitude associated with the conditioned analog signal to generate an adjusted signal amplitude; and
an amplitude modulator, that is configured to control a first quantum gate to cause the first quantum gate to adjust a state of the qubit based on the adjusted signal amplitude.

13. The system of claim 12, wherein the qubit phase encoding circuit comprises:
a phase-locked loop that is configured to adjust the phase associated with the conditioned analog signal to generate a stabilized signal phase; and
a phase modulator configured to control a second quantum gate to cause the second quantum gate to adjust the state of the qubit based on the stabilized signal phase, wherein the second quantum gate is different than the first quantum gate.

14. The system of claim 13, wherein the first quantum gate comprises an S-gate that is operable to adjust an amplitude of the state of the qubit, and wherein the second quantum gate comprises a U-gate that is operable to adjust a phase of the state of the qubit.

15. The system of claim 11, wherein the qubit that is encoded to store the continuous analog signal indicates the input analog signal without rounding errors and without sampling errors.

16. A method comprising:
receiving an input analog signal, wherein the input analog signal is a signal that varies continuously in amplitude and frequency over time and can take any value within a predetermined range;
generating a conditioned analog signal from the input analog signal; and
encoding a register of qubits to represent the conditioned analog signal by storing a continuous analog signal among the register of qubits, wherein encoding the register of qubits comprises:
encoding at least a portion of an amplitude associated with the conditioned analog signal into a first qubit of the register of qubits, and
encoding at least a portion of a phase associated with the conditioned analog signal into the first qubit.

17. The method of claim 16, wherein:
receiving the input analog signal comprises receiving a continuous stream of analog data; and
encoding the register of qubits to represent the conditioned analog signal comprises continuously modifying a state of at least a subset of the register of qubits based on the continuous stream of analog data.

18. The method of claim 16, wherein generating the conditioned analog signal from the input analog signal comprises (i) filtering the input analog signal, (ii) amplifying the input analog signal, and (iii) normalizing the input analog signal.

19. The method of claim 16, wherein:
encoding the register of qubits comprises encoding each qubit of the register of qubits with non-overlapping data based on the portion of the amplitude of the conditioned analog signal and the portion of the phase of the conditioned analog signal; or
encoding the register of qubits comprises (i) encoding the first qubit of the register of qubits based on the amplitude of the conditioned analog signal and the phase of the conditioned analog signal, and (ii) duplicating the first qubit to generate a second qubit of the register of qubits, the first qubit and the second qubit indicating identical data of the continuous analog signal.

20. The method of claim 16, further comprising:
performing a quantum Fourier transform on the register of qubits to estimate a summed amplitude among the register of qubits; and
generating one or more control instructions for controlling a real-world operation based at least in part on the summed amplitude.
